(19) United States
(12) Patent Application Publication
(10) Pub. No.: US 2007/0256938 A1
(43) Pub. Date: Nov. 8, 2007

(54) Method for Electro-Chemical Processing of a Work Piece and Electrode for Such a Method

(76) Inventor: Carl Johannes Fruth, Parsberg (DE)

Correspondence Address: SIMPSON & SIMPSON, PLLC, 5555 MAIN STREET, WILLIAMSVILLE, NY, 14221-5406, US

(21) Appl. No.: 11/791,439

(22) PCT Filed: Sep. 26, 2005
(86) PCT No.: PCT/EP05/10384

§ 371 Date: May 23, 2007

(30) Foreign Application Priority Data
Nov. 29, 2004 (DE) 10 2004 057 527.4

(51) Int. Cl. B23H 3/00

(52) U.S. Cl. 205/668

(57) ABSTRACT

The invention concerns a method for processing a work piece (21), in which a work piece (21) is constructed in layers (3) from a conductive material using a rapid prototyping process. The work piece (21) constructed in layers (3) is contacted in an anodic manner. Then, a tool (1) is disposed opposite to a to-be-processed site of the work piece (21) such that a gap (50) remains therebetween. The tool (1) is contacted in a cathodic manner and a conductive medium (32) is brought into the gap (50) so that current flows by applying an electronic voltage and metal ions are dissolved from the work piece (21) by electrolysis, whereby a defined removal of material from the work piece (21) takes place. The invention further concerns a method for producing a tool to be utilized as an electrode (1) in an ECM method and an electrode (1) for usage in an ECM method for electro-chemical processing of a work piece (21).

### TECHNICAL FIELD

The present invention concerns various methods for electro-chemical processing of a work piece. Further, the invention concerns methods for manufacturing a tool to be used as an electrode in an electro-chemical processing method, which tool is designed for electro-chemical processing of a work piece. Moreover, the invention concerns electrodes that are designed for usage in a method for electro-chemical processing of a work piece.

### BACKGROUND OF THE INVENTION

For processing work pieces and in particular for manufacturing specified work piece surfaces, material removing methods, such as milling and lathing, are generally known. A problem of these material removal methods is that small and complex work piece surfaces are not producible or only in a relatively cost-ineffective manner.

In addition, for special applications, the removal of material using electrical discharge erosion, electrolytic machining and by metal etching is known. These three methods have in common that electric current is responsible for the desired material removal from the work piece. All three above-noted methods take place in a liquid work medium.

In electrical discharge erosion, material removal or material migration takes place between two electrically-conducting contacts. In this technique, the electrodes are the shaping tool and the to-be-processed work piece. The electrical discharges in an erosion gap constitute temporal and localized discharges, whose effect on the work piece surface is characterized by cone shaped removals and removed craters. The machines driven with a pulse- or relaxation-generator can realize the methods of sinking, wire eroding, grinding and sawing. Nowadays, electrodes for the electrical discharge erosion method are produced by milling of graphite or copper, because these materials exhibit a burn-off behavior that is favorable for electrical discharge erosion. Other materials are only suitable therefor with severe restrictions.

However, in electrical discharge erosion, it is disadvantageous that the electrodes are subjected to material wear and tear and the processing of a work piece takes a long time and is thus expensive. Accordingly, this method is only utilized for very special work pieces. An economic series processing of work pieces has not been previously achievable.

In the so-called electrolytic machining, which is also known as electro-chemical milling (ECM method), it concerns an electro-chemical processing method, in which metal atoms of the anode—i.e. the work piece—go into solution under the influence of a DC voltage in an aqueous solution of salts or acids as electrolytes. It is the reverse of galvanization. In this method, the DC current flowing between the work piece and the tool shapes the work piece to the preset form by dissolving away of material particles. For determining the geometry, an electrolyte is brought up to a speed of 30 m/s by an insulated nozzle and achieves a very high material removal rate at current densities of 250 A/cm². In particular, work piece geometries and work piece surfaces having a roughness as low as Rₜ=0.5 μm can be achieved without burr. Characteristic of this electrolytic machining is that very high material removal speeds and quality can be achieved. As was already indicated above, one electrode is the work piece in this method and the other electrode is the tool that has the desired profile of the work piece, so that the corresponding desired material removal takes place on the work piece. Previously, the electrolytic machining or ECM method was often utilized only for very special components, in particular for the effective deburing of metallic serial-components and/or for the surface smoothing of, e.g., turbine vanes. Recently, it has been also researched to utilize this process for manufacturing of micro-components and very precise mini-structures.

One reason for using the ECM method only for special components is that a very good flushing is necessary in order to sustain the material removal process and another reason is metal ions are removed from the work piece along the entire gap between the tool acting as the electrode and the to-be-processed work piece proportional to the current flow—as a rule, proportional to the gap distance—, whereby the required precision is not always achieved. Moreover, deep slots or similar geometries in work pieces are hardly possible with the previous electrodes for electrolyte machining, because the necessary flushing ducts can not be generated or only with substantial effort. For further information concerning electrolytic machining of work pieces, reference is made to the following documents as examples thereof: CH 538 906 A, DE 199 59 593 A1, DE 1 813 017 A, DE 1 765 890 B1, DE 17 65 890 B, U.S. Pat. No. 5,738,777, DD 287 617 A7.

GB 2 096 518 A discloses a method and a device for electrical processing of a work piece. Herein, a so-called EDM method and an ECM method are combined with each other with the usage of a strong electrolyte. The work piece, as well as a tool utilized herein for shaping the work piece, are not described in detail. Only customary copper-graphite-wires or tungsten electrodes are mentioned as electrodes.

In U.S. Pat. No. 5,833,835, a method for electro-chemical processing of a work piece in an electrolyte by applying bi-polar electrical impulses between the work piece and an electrically-conductive electrode is disclosed. Again, reference to generally customary electrodes is also made herein.

In DE 101 11 019 A1, a device and a method for structuring a surface of an electrically-conductive object, which is connected as an anode, by an ECM method are described. The disclosed ECM apparatus includes an anode and cathode; an electrolyte is disposed between the cathode and the to-be-structured surface. The structure on the surface of the object is produced using a mask integrated in the ECM apparatus. Moreover, it is also disclosed that the cathode, the mask and the to-be-structured surface can be pressed together like a sandwich.

In DE 102 37 324 A1, a method for producing an electrode for the electro-chemical processing of a work piece and an electrode produced according to the method are disclosed. Herein, an electrode body made of an electrically-conducting support material is coated on the surface with an insulating material. Then, a removal of the insulating material takes place in portions of the surface of the electrode body, which portions correspond to the structure that should be formed in the surface of the work piece by electro-chemical processing.

EP 0 223 401 A1 shows a partially-conducting cathode for an electro-chemical processing. The cathode comprises a processing surface, of which at least a part is comprised of non-conducting and conducting materials that are layered on top of each other, wherein the spacing and the thickness of the non-conducting and conducting materials are selected so that a too-deep removal of material on a convex radius of the work piece surface is decreased.

In addition, a PEM method, which is an adaptation of the classic electro-chemical method, is noted. This method was developed by the firm PEM Technologiegesellschaft für electro-chemische Bearbeitung mbH/Deutschland. The PEM technology concerns a modified variation of the above-explained ECM method and thus is to be subsumed under the generic ECM method and/or electrolyte milling or general electro-chemical processing. The PEM technology relies upon the direct and largely proportional dependence of the gap distance between the electrode and the work piece and the consequent achievable geometry- or surface precisions. The necessary flushing of the gap with fresh electrolyte can no longer be realized at gaps of about 10 μm. Accordingly, this gap distance represents the limit for the classic EMC [sic, ECM] method. Since a simultaneous removal of material and flushing is not possible in the classic ECM method, the two procedures are alternately performed in the PEM method. A removal of material takes place in a narrowest-possible gap; the flushing of the gap takes place in a largest-possible gap (several tenths of a millimeter). This leads to an oscillating electrode movement. In the PEM method, approximately 50 Hz is realized. That is, higher surface precisions can be achieved by changing the gap width. Thus, it concerns, in principle, a cavity sinking method with a vibrating electrode. A DC voltage is applied between the electrode and the work piece, as was described above with respect to the ECM method, whereby the work piece dissolves away in accordance with the geometry of the descending electrode. Components thereby result having arbitrarily complex geometric shapes in nearly all electrically-conducting metals, such as e.g., highly-aged steel, rolled steel, powder-metallurgic steel as well as super alloys (e.g., nickel-based alloy).

Access to applications is thus opened up with the PEM method that could not formerly be produced, or only uneconomically produced, with the known methods of electrical discharge erosion or with the classic electro-chemical removal of material.

The electrodes necessary for the performance of the ECM method and the PEM method were formerly produced with the classic methods, such as milling, erosion or etching.

### SUMMARY OF THE INVENTION

According to a first aspect of the present invention, a method for electro-chemical processing of a work piece is proposed, in which a work piece is constructed in layers from a conductive material, in particular, using rapid prototyping technology. The work piece constructed in layers is contacted in an anodic manner and a tool serving as an electrode is disposed opposite to a to-be-processed site of the work piece such that a gap remains therebetween. The tool is contacted in a cathodic manner and a conductive medium is brought into the gap between the work piece and the tool so that current flows by applying an electronic voltage and metal ions are dissolved from the work piece by electrolysis, whereby a defined removal of material from the work piece takes place according to the contour of the tool.

A further aspect of the present invention comprises a [sic, method] for processing a work piece, in which, in alternative to the above-mentioned inventive processing method, the tool serving as an electrode is produced in a layered-construction manner using rapid prototyping technology instead of the work piece. According to the invention, a metallic work piece is contacted in an anodic manner and a tool constructed in layers using a rapid prototyping method is disposed opposite to a to-be-processed site of the work piece such that a gap remains therebetween. The tool is contacted in a cathodic manner and a conductive medium is brought into the gap so that current flows by applying an electronic voltage and metal ions are dissolved from the work piece by electrolysis, whereby a defined removal of material from the work piece takes place. It is noted that a metal layer is applied to at least a part of the outer side of the produced electrode, in case the individual layers, from which it was constructed, are comprised of an electrically non-conductive material.

An alternative of the above-mentioned method comprises the production in a layered-construction manner of the work piece as well as the tool serving as the electrode.

According to a further aspect of the present invention, a method for producing a tool to be utilized as an electrode in an ECM method is proposed, which tool is designed for electro-chemical processing of a work piece. In this aspect, the electrode is produced in a layered-construction manner using a rapid prototyping method, wherein an outer contour desired for the removal of material from the work piece in the ECM method is fabricated on the electrode. In case the layers of the produced electrode are comprised of an electrically non-conducting material, a metal layer is applied in a known manner to at least a part of the outer side of the produced electrode that should effect a removal of material from the work piece. In the latter case, the application of the metal layer can take place, e.g., by galvanization, in a CVD method, PVD method, varnishing, spraying or the like.

In an exemplary embodiment of the above-mentioned inventive method, during production of the electrode or the tool in a layered-construction manner, at least one duct is fabricated, which duct leads to the outer side of the electrode or the tool, respectively, in order to supply a conductive medium into a working gap between the electrode and the work piece during use of the electrode or the tool, respectively, in the ECM method or to be able to suction the conductive medium through the duct.

A further aspect of the present invention concerns a method for producing a tool to be used as an electrode in an ECM method for the electro-chemical processing of a work piece. This further inventive method comprises the steps: producing a body from a plurality of layers using a rapid prototyping method, the respective contours of the body, when taken together, forming the outer contour of the electrode body desired for the removal of material from a work piece in the ECM method. Thereafter, a molding of the body comprised of a plurality of layers takes place for producing a casting mold, the casting mold inner contours having, as a result of the molding, the outer contour of the electrode body desired for the removal of material from a work piece in the ECM method. Then, an electrode body is cast in the produced casting mold, whereby the outer contour of the electrode body desired for the removal of material from a work piece in the ECM method is achieved. Finally, an electrically conductive layer is applied to at least a part of the surface of the cast electrode body, in case the electrode body itself is comprised of a non-conductive material. The methods for applying the electrically conductive layer, such as a metal coating, are generally known. In particular, reference is made to the above-explained, exemplary selection of suitable metal coating methods.

A further aspect of the present invention concerns an electrode for usage in an ECM method for electro-chemical processing of a work piece. This inventive electrode comprises an electrode body comprised of a plurality of layers produced using rapid prototyping technology, the respective contours of the layers together forming the outer contour of the electrode body desired for the removal of material from a work piece in the ECM method. An electrically conductive layer is applied to at least a part of the surface of this electrode body, in case the layers are not comprised of a conductive material.

Finally, a further aspect of the present invention concerns an electrode for usage in an ECM method for electro-chemical processing of a work piece. In this aspect, the inventive electrode comprises an electrode body having an outer contour desired for the removal of material from a work piece in the ECM method. In this aspect, the electrode body is produced by casting in a casting mold, the casting mold inner contour is set by molding of a body that is composed of a plurality of layers produced using rapid prototyping technology, and the respective contours of the layers, when taken together, form the outer contour of the electrode body desired for the removal of material from a work piece in the ECM method.

The concept underlying the invention is to meld rapid prototyping technology, which is known in completely other fields, for the layered-construction of a body having complex surface structures with the ECM method. For the first time, precise metallic work pieces and tools can be produced in a simple, cost-effective manner and in a very short time. In particular, electrodes for usage in ECM methods are producible for the first time with previously unachievable surface structures and precisions. Thus, the previous ECM methods are now employable for completely new work piece processings. Due to the precise and cost-effective production of electrodes in a layered-construction manner corresponding to the rapid prototyping technologies, which are known for layered-construction in other fields, complex work pieces can thus also be economically fabricated in the known ECM methods. In particular, because the electrodes are not subjected to wear and tear in the ECM methods, the particular advantages of layered-construction of the electrodes now can be utilized in large series-manufacturing of work pieces with complex surfaces and surfaces having high precision.

In particular, it is also possible for the first time to provide flushing- and/or suction ducts in the electrodes for the ECM method or also in the work pieces, which are constructed in layers, and are to be processed using an ECM method. Especially complex flushing- and/or suction duct systems, in particular, can also be produced in the electrodes (i.e. in the work piece and/or in the tool for the ECM method). In this connection, a flushing- or suction duct system comprises a plurality of ducts that lead to different sites on the surface of the electrodes and enable a specific supply or discharge of electrolyte.

In summary, it is to be understood that the proposed combination of ECM methods and a layered-construction of electrodes using rapid prototyping methods enables the realization of fast and automatable systems for producing complex work pieces. High precision and complex structures on the work pieces can be achieved. In particular, very smooth components, i.e. having low roughness, are also economically producible. In particular, any metallic material is also usable as the material. There are, in principle, no significant limitations and many copies of work pieces are producible in an arbitrary manner. For the first time, an optimization of the flushing of the electrolyte in the ECM method can be realized. As was explained above, the above-mentioned PEM technology is, in particular, combinable with the proposed inventive methods.

In a further exemplary embodiment of the present invention, a flushing and/or suction of the electrolyte can, e.g., alternatively take place. In a further exemplary embodiment, ducts or bores specific only for supplying and ducts or bores specific only for suctioning can alternatively be provided.

A further exemplary embodiment of the present inventive method provides that the application of ultrasound is superimposed during the metal ion removal in order to, e.g., increase the flushing effect.

A further exemplary embodiment of the present invention provides that processing takes place with vibrations in various effective directions again in order to increase the flushing effect or to increase the precision of the material removal from the work piece. In this way, complex, specific shapes, such as screw threads, under-cuts, inner threads or gear geometries could be produced.

In particular, it is possible using the inventive method to simultaneously process a plurality of work pieces made of the same or different metals in the ECM method.

In a further exemplary embodiment of the present invention, the processing in an ECM method of a plurality of work pieces can take place separately in a first phase, such as e.g., a contour-approximating electrolytic machining, and in a second phase, a common processing of the plurality of work pieces, e.g., an electrolytic machining for achieving a specified counter on both components, takes place.

The layered-construction methods in rapid prototyping technologies and/or the rapid prototyping methods, which come into use for the present invention, could be methods that fabricate metallic work pieces as well as synthetic material components. Methods for fabrication of metallic components could, e.g., be the following methods: DMLS of the firms EOS and MCP, IMLS of the firm 3D Systems, Lasercusing of the firm Konzeptlaser, Laserschmelzen of the firm Trumpf, Electron Beam Melting of the firm Arcam, and Electron Beam Sintering. An example of a layered-construction method, which generates synthetic material components and can come into use in the present invention, is stereo-lithography.

Inventive electrodes can be hollow according to an exemplary embodiment of the present invention and/or can possess a special filling. The filling can, in particular, be a conductive web or powder in order to facilitate the transmission of high amounts of currents.

In a further exemplary embodiment of the present invention, inventive electrodes can also have an inner crystal lattice structure or a sintered structure or also can be constructed in shells. In particular, multi-part constructed electrodes for multi-phase processing are also possible. The inventive construction of electrodes for usage in ECM methods also makes possible different structural areas on electrodes.

Inventive electrodes for an ECM method can also be produced that are produced by a casting method in connection with the rapid prototyping layered-construction. As casting methods, vacuum casting, front casting [Frontguss], investment casting, waste-wax casting, Gilvac method, precision casting, etc. are suitable, so that the inventive electrodes result from a positive mold. However, electrodes in layered-construction are also producible for usage in ECM methods that result by a casting method from a negative mold, such as vacuum casting, front casting [Frontguss], investment casting, precision investment casting, Gilvac method, precision casting, etc.

Additionally, it is noted that not only the methods expressly mentioned herein are to be subsumed under the term “rapid prototyping method” and “rapid prototyping technology” with reference to the present invention, but also all further methods and technologies that a skilled person associates with the field of rapid prototyping methods. In general, all methods that construct a body in layers fall within this term. Moreover, all possible combinations of individual layer-construction methods are to be subsumed under the above-mentioned terms.

### BRIEF DESCRIPTION OF THE DRAWINGS

For a better explanation and understanding, several exemplary embodiments of the present invention are described in greater detail in the following with the assistance of the appended drawings.

FIG. 1 shows various steps I-IV of an inventive method for electro-chemical processing of a work piece with an electrode produced in a layered-construction manner;

FIG. 2 shows a detail of the method step IV according to FIG. 1;

FIG. 3 shows a sectional view similar to FIG. 2 of an electrode and a work piece, wherein the electrode shape is modified as compared to FIG. 2;

FIG. 4 shows a sectional view corresponding to FIGS. 2 and 3 of a work piece and an electrode, wherein the electrode, as compared to the embodiments in FIGS. 2 and 3, is provided with a metal layer;

FIG. 5 shows a multi-part electrode for the ECM method, whose parts are comprised of different materials;

FIG. 6 shows a further embodiment of an inventive hollow electrode for the ECM method;

FIG. 7 shows a further exemplary embodiment of an inventive electrode having flushing- and suction-ducts for the ECM method;

FIG. 8 shows a further exemplary embodiment of an inventive electrode for the ECM method, which electrode is constructed in a hollow manner and has a filling within a conductive material layer;

FIG. 9 shows a further exemplary embodiment of an inventive electrode for the ECM method, which electrode is constructed in a hollow manner and has a conductive coating as well as a filling;

FIGS. 10a)-h) show various surface structures of inventive electrodes;

FIG. 11 shows a side view of a further exemplary embodiment of an electrode;

FIG. 12 shows an inventive electrode for the ECM method produced in a casting mold constructed in layers;

FIG. 13 shows a further exemplary embodiment of an inventive electrode for the ECM method that is shaped by casting in a casting mold produced in a layered-construction manner,

FIG. 14 shows a further exemplary embodiment of the invention comprising an electrode for simultaneous processing of two or more work pieces,

FIG. 15 shows a further exemplary embodiment of the invention comprising two electrodes for simultaneous processing of two different areas of a work piece.

### DESCRIPTION OF THE EXEMPLARY EMBODIMENTS OF THE PRESENT INVENTION

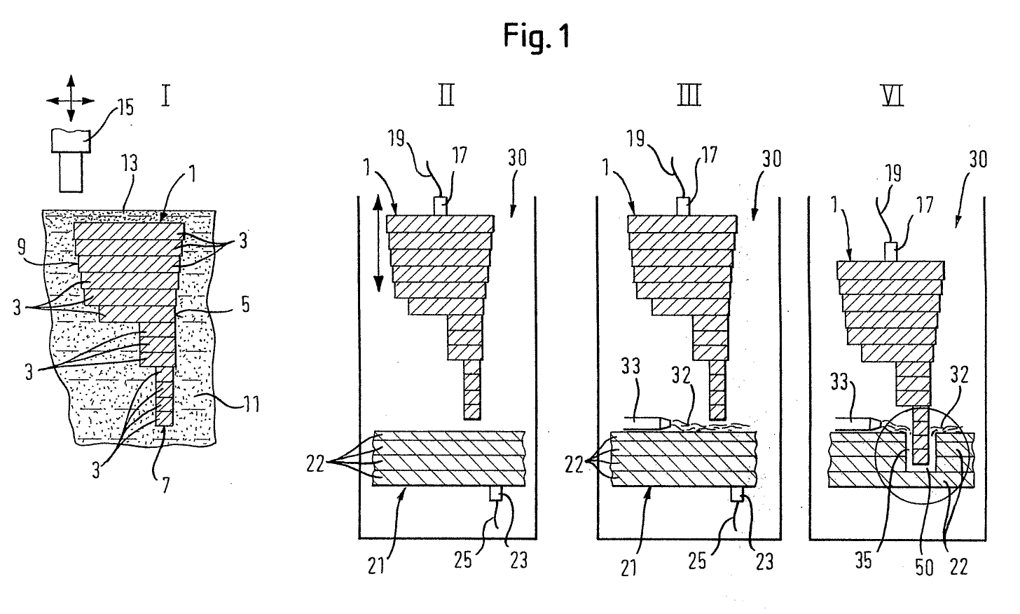

A first exemplary embodiment of the present invention is explained in more detail in the following with reference to FIG. 1. The stereo-lithography process utilized herein is purely exemplary and can be replaced by other above-mentioned layered-construction processes.

As is shown in partial step I of FIG. 1, an electrode body 1 is constructed in layers in a known manner in a RP-machine (rapid prototyping) in a liquid synthetic material bath 11. For this purpose, the desired cross section of layer 3 of electrode body 1 is fabricated using a laser 15 that is, in the view illustrated in FIG. 1, movable in the horizontal plane and is also height-adjustable. The laser 15 is moved in the horizontal plane according to the desired contour and a part of the synthetic material layer 13 of the liquid synthetic material 11 is exposed with appropriate illumination and is thus cured. Consequently, arbitrary contours and layer shapes 3 can be fabricated.

As soon as the desired layer 3 is completed, the just exposed and cured synthetic material part is downwardly lowered to the new desired layer thickness. The new liquid synthetic material layer 13 above the top layer 3 is again exposed and thereby hardened. Layers 3 provided in an arbitrarily contourable manner and possibly with openings, etc., result thereby, which layers together form an electrode body 1. As shown in FIG. 1/I, an electrode 1 can thus obtain different contours 5 and 9 on different sides.

This electrode body 1 constructed in layers in the stereo-lithography method is comprised of synthetic material in the described example. The electrode body 1 can be made conductive by mixing appropriate materials into the synthetic material that is curable by the laser 15. In case this conductivity does not suffice in order to utilize such an electrode body 1 in the ECM method, such an electrode 1 can also be provided with a metallic coating 2, as will be explained below.

It will be assumed for steps II-IV that the electrode body 1 is electrically conductive. In step II, the electrode 1 is provided with an electronic terminal connection 17 that is connected with the DC power source via a cable 19. A work piece 21 is likewise provided with a terminal connection 23 and is connected with the DC power source via a cable 25. In this embodiment, the work piece 21 forms the anode; the tool, i.e. the electrode 1, forms the cathode. This assembly is disposed in a known ECM-machine or a PEM-machine.

In step III, an electrolyte 32 is introduced by a nozzle 33 and via an intermediate space 32 into a working gap 50 between the electrode body 1 and the work piece 21. The desired material removal from the work piece 21 takes place thereby. For further details in this connection, reference is made to the known operating methods of ECM-machines or PEM-machines.

As shown in step IV, a desired cavity 35 is now produced in the work piece 21 by gradually adjusting the height of the electrode 1 and/or the work piece 21. This cavity 35 can then achieve a desired defined contour corresponding to the outer contour of the electrode body 1 that was fabricated by the layered-construction method.

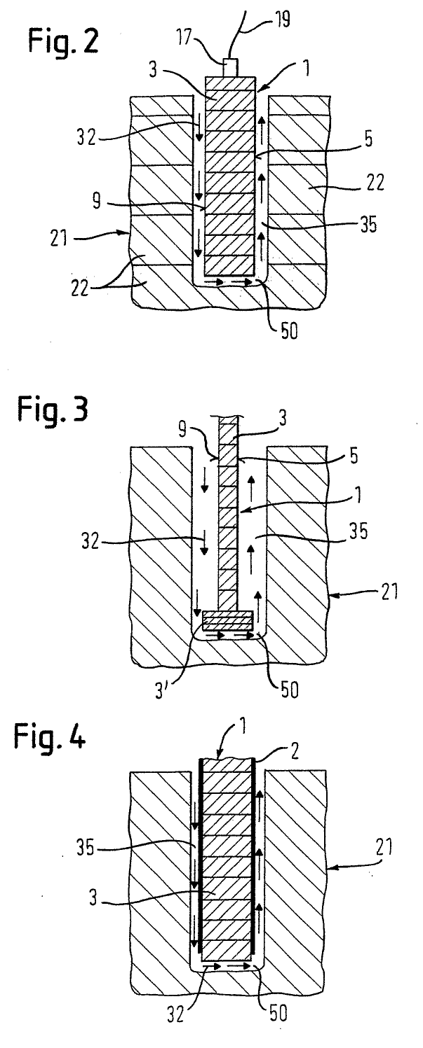

In FIG. 2, a detailed view of the method step IV of FIG. 1 is shown. As will become clearer therefrom, the electrolyte 32 flows in on one side, migrates through the working gap 50 and is then exhausted from the cavity 35. Material removal takes place substantially in the working gap 50. Substantially no material removal takes place on the sides 5 and 9 of the electrode body 1.

The illustration in FIG. 3 substantially corresponds to FIG. 2. Merely the shape of the electrode 1 is modified. Herein, a forward part has layers with a layer thickness 3′; the rearward part, which forms the stem, comprises thicker layers 3. This electrode shape can be advantageous during the processing of work piece 21, because it is ensured that no material removal, in fact, will take place on the sides 5 and 9.

As already explained in the background section, FIG. 4 shows a view basically equivalent to the illustration of FIGS. 2 and 3. Herein, the electrode is comprised of an electrode body 1 and a coating 2. The electrode body 1 can again be comprised of synthetic material in this embodiment; the coating 2 is a metallic coating. The coating can be applied, e.g., by vapor deposition or by lacquering on the electrode body 1. The application of the metal layer 2 is also possible by galvanization or the like.

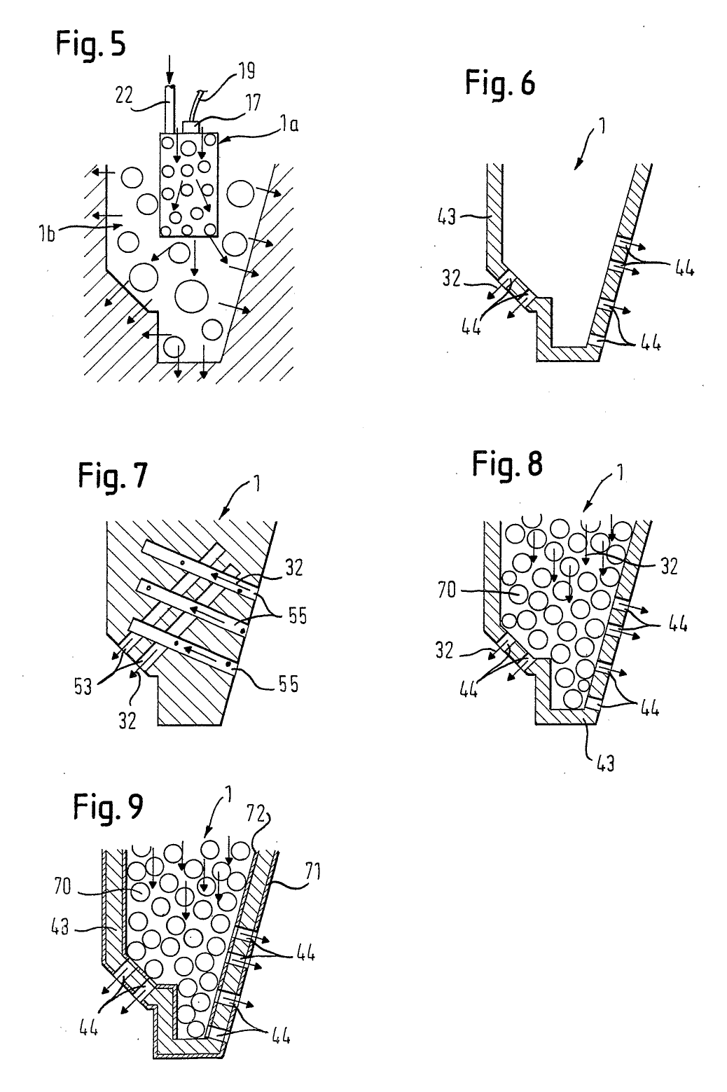

In FIG. 5, a further alternative embodiment of the inventive electrode is shown. Herein, the electrode 1 is comprised of two parts 1a and 1b. The electrode body 1a is inserted into the electrode body 1b. Both are comprised of a sintered body constructed in the layered-construction manner. The porosity of parts 1a and 1b is different in this embodiment. A terminal connection 17 for the current and an electrolyte guide 22 are provided on the electrode body 1a. The electrolyte 32 is introduced into the sintered body 1a of the electrode via this electrolyte guide 22 and flows out of the electrode body 1a into part 1b due to the high porosity. As is thus apparent, the electrode body part 1b has a complex outer contour, whereby the shape of the material removal from the work piece 21 is controllable in accordance therewith.

FIG. 6 shows a further electrode for ECM methods having a hollow electrode body 1 that comprises a wall 43 made of sintered metal constructed in layers. Guide ducts 44 are provided in the walls 43, which ducts 44 enable a specified supply of an electrolyte 32. The guide ducts 44 can be fabricated already when constructing the wall 43 in the layered manner or they are subsequently made separately by boring or the like.

FIG. 7 shows a further exemplary embodiment of an electrode body 1. In this embodiment, a plurality of electrolyte guide ducts 53 and electrolyte suction ducts 55 are provided in the electrode body 1. These ducts 53, 55 were already constructed in the RP method in step I of the inventive method according to FIG. 1.

FIG. 8 shows yet another exemplary embodiment of a hollow electrode 1 constructed in an inventive manner, the wall 43 of which is constructed in layers using RP technology like the wall of the electrode according to FIG. 6, but supplemental to the electrode shown in FIG. 6, it comprises a filling 70. The filling 70 can serve to reinforce and stabilize the electrode 1. It can, however, also contribute to increasing the conductivity of the electrode. The materials therefor can be selected accordingly. It is to be noted that, in principle, the filling 70 can also be simultaneously produced during the construction of the wall 70 in layers using the RP technique. However, a separate filling 70 in the hollow space is also possible.

FIG. 9 shows yet another exemplary embodiment of an inventive electrode 1. Supplemental to the electrode 1 shown in FIG. 8, the wall 43, which is constructed from non-conductive layers in certain circumstances, is provided with at least one conductive layer 71, 72. As shown, one inner layer 72 and one outer layer 71 made of conductive material, in particular, can be provided.

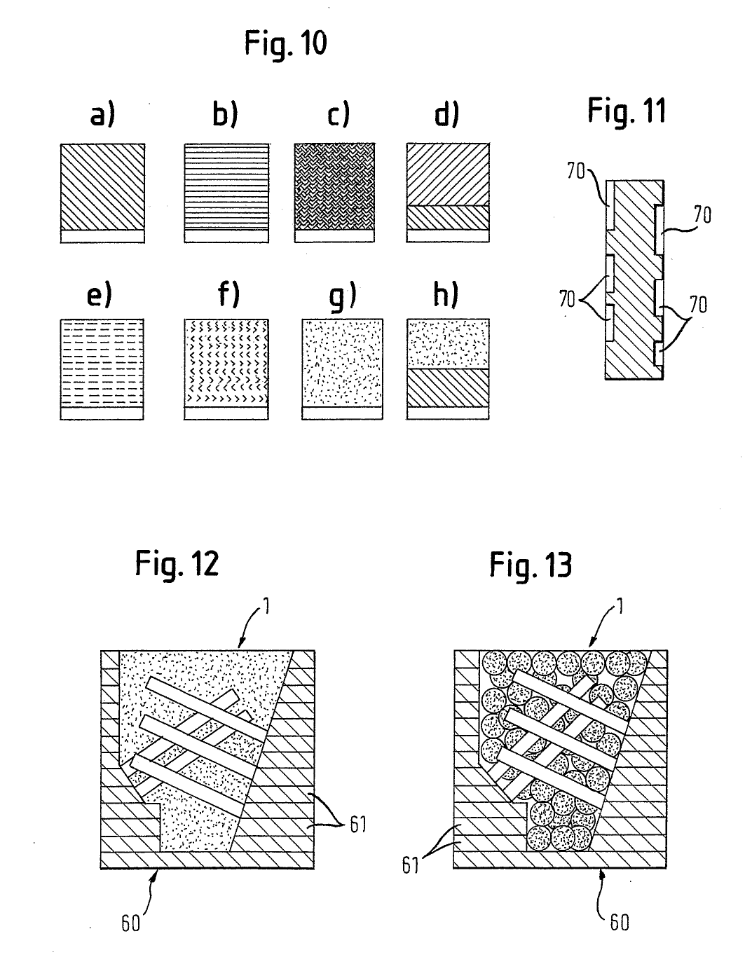

FIGS. 10a)-10h) show various surface structures that are producible on an electrode 1 for an ECM method according to the present invention. Thus, grooves, conductive channels, elevations, special-structured surfaces and surface gaps or the like can be made that improve the supply and discharge of electrolyte in the ECM method, or with which it can be better controlled where material removal from the work piece takes place.

FIG. 11 shows a cross-sectional view of an electrode body 1 constructed in layers, in which side recesses 70 are provided in order to be able to better control the removal of material from the work piece in the ECM method.

In FIG. 12, a cross-sectional view inside a casting mold 60 made in the rapid prototyping layered-construction is shown. An electrode body 1 is fabricated in this casting mold 60 by of a synthetic material or a metal or an alloy.

The same also applies for the electrode body illustrated in FIG. 13, which has a porous structure by casting of sintered metal. In this embodiment also, the mold 60 is again constructed with individual layers 61 using the RP technique.

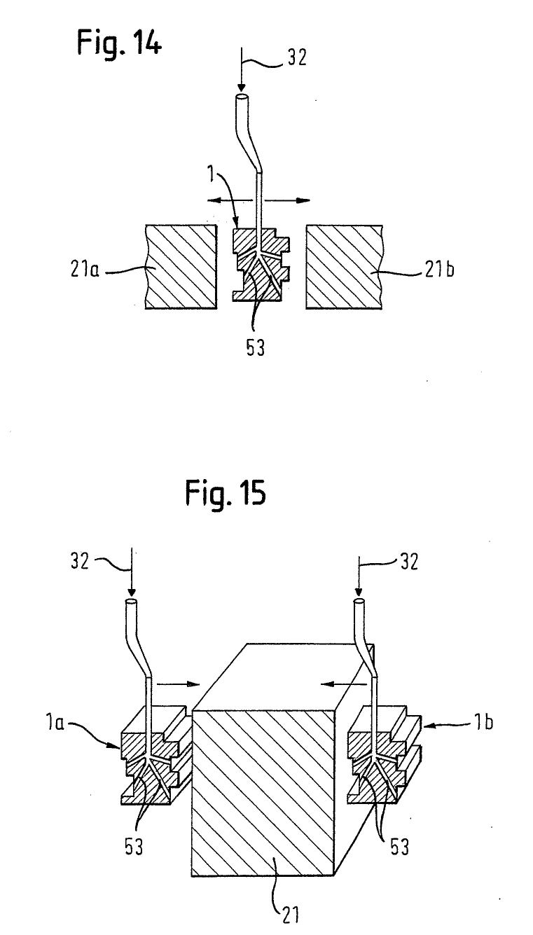

In FIG. 14, an assembly in an ECM-machine is shown, which shows an inventive electrode 1 that horizontally oscillates. In this embodiment, work pieces 21a and 21b are disposed on two mutually-opposing sides of the electrode 1, which work pieces are to be processed using the EMC technique. By these particular possibilities for the inventive production of electrodes 1, different processings of work pieces 21a and 21b can now also be simultaneously performed with one electrode 1. In principle, a simultaneous processing of two work pieces 21a, 21b is, however, possible by means of reciprocating oscillation of the electrode 1. This type of processing of a plurality of work pieces 21a, 21b is therefore not confined to electrodes according to the present invention. For this purpose, conventional electrodes can also be utilized.

Finally, FIG. 15 shows an assembly that is similar to the assembly in FIG. 14. However, contrary to the assembly of FIG. 14, two electrodes 1a and 1b are provided in this embodiment, which process two different sites of a work piece 21 in the ECM technique. The electrodes 1a and 1b can, but are not required to, be produced in the layered-construction.

1-19. (canceled)

20. A method for processing a work piece by electrolytic machining, comprising the steps of:
contacting a metallic work piece anodically;
constructing an ECM electrode from a plurality of layers of a conductive material using a rapid prototyping method, wherein the plurality of layers form a desired outer contour of the ECM electrode, and said ECM electrode is disposed opposite to a to-be-processed site of the metallic work piece such that a gap remains therebetween;
contacting the ECM electrode cathodically; and,
introducing a conductive medium into the gap so that a current flows by applying a voltage, resulting in dissolution of metal ions from the work piece by electrolysis, wherein a defined removal of material from the work piece takes place.

21. The method according to claim 20, wherein said metallic work piece is produced using a method selected from the group consisting of: a laser sintering method, a laser melting method, an electronic beam melting method, and an electronic sintering method.

22. The method according to claim 20, wherein the metallic work piece is constructed from a plurality of layers of conductive material.

23. The method according to claim 20, further comprising the steps of alternatively flushing and suctioning of the conductive medium.

24. The method according to claim 23, wherein said flushing of the conductive medium is carried out through flushing channels or flushing bores and said suctioning of the conductive medium is carried out through suctioning channels or suctioning bores.

25. The method according to claim 20, further comprising the step of superimposing ultrasound during the step of introducing the conductive medium into the gap.

26. The method according to claim 20, further comprising the step of applying vibrations in various effective directions during the step of introducing the conductive medium into the gap.

27. The method according to claim 20, wherein a plurality of metallic work pieces are processed simultaneously, said plurality of metallic work pieces comprising same or different metals.

28. The method according to claim 27, wherein the processing of the plurality of metallic work pieces is performed in first and second phase processing steps.

29. A method for producing an ECM electrode adapted and constructed for use in an ECM processing method, comprising the steps of:
producing a plurality of stacked layers from a conductive material using a rapid prototyping method, and
generating a desired outer contour of the ECM electrode during the step of producing the plurality of stacked layers.

30. The method according to claim 29, further comprising the step of fabricating at least one duct during the step of producing the plurality of stacked layers, the at least one duct leading to an outer side of the electrode and arranged to supply a conductive medium into a working gap between the ECM electrode and a work piece during use of the ECM electrode in the ECM processing method.

31. The method according to claim 29, further comprising the step of fabricating at least one duct during the step of producing the plurality of stacked layers, the at least one duct leading to an outer side of the ECM electrode and arranged to discharge a conductive medium from a working gap between the ECM electrode and a work piece during use of the ECM electrode in the ECM processing method.

32. An ECM electrode adapted and constructed for use in an ECM processing method for electro-chemical processing of a work piece, said ECM electrode comprising an electrode body constructed of a plurality of layers of a conductive material and produced by a rapid prototyping method, wherein a combination of each respective contour of the plurality of layers forms an outer contour of the electrode body, and said outer contour is desired for a removal of material from said work piece in the ECM processing method.

33. The ECM electrode of claim 32, wherein each respective layer of said plurality of layers of the electrode body are shaped such that at least one duct is formed in the electrode body and arranged to enable a supply or a discharge of a medium in an area surrounding the ECM electrode.

34. The ECM electrode of claim 32, wherein at least a portion of a surface of the electrode body has a defined surface structure formed during production of the electrode body by the rapid prototyping method.

35. The ECM electrode of claim 32 further comprising a terminal connection device arranged to receive a voltage to be applied to the ECM electrode.

36. The ECM electrode of claim 32, wherein the electrode body comprises a hollow cavity, a special filling or combinations thereof.

37. The ECM electrode of claim 36 wherein the special filling comprises a conductive powder, a conductive woven or combinations thereof.

38. The ECM electrode of claim 32, wherein the ECM electrode comprises an inner sinter structure.

39. The ECM electrode of claim 32, wherein the ECM electrode is constructed of a plurality of shells.

40. The ECM electrode of claim 32, wherein the ECM electrode is constructed of a plurality of parts arranged to be assembled together for a multi step processing of said work piece.
